(19) United States
(12) Patent Application Publication
(10) Pub. No.: US 2015/0121073 A1
(43) Pub. Date: Apr. 30, 2015

(54) SOFTWARE FINGERPRINTING

(71) Applicant: Andrew Augustine Wajs, Hoofddorp (NL)

(72) Inventor: Andrew Augustine Wajs, Hoofddorp (NL)

(73) Assignee: Irdeto B.V., Hoofddorp (NL)

(21) Appl. No.: 14/387,516

(22) PCT Filed: Mar. 23, 2012
(86) PCT No.: PCT/EP2012/055193

§ 371 Date: Dec. 18, 2014

(51) Int. Cl. H04L 29/06; G06F 9/44

(52) U.S. Cl. CPC H04L 63/10; H04L 63/0428; G06F 8/71
USPC 713/168; 726/29

(57) ABSTRACT

A method of providing a receiver with a version of an initial item of software, the method comprising: for each of a plurality of sections of the initial item of software that together form the initial item of software, obtaining one or more respective versions of that section, wherein for at least one of the sections a respective plurality of different versions of that section are obtained; for each of the plurality of sections of the initial item of software, selecting a respective version of that section to be used by the receiver, said selecting being arranged so that the receiver is identifiable from the set of selected versions; and providing the receiver with a version of the initial item of software by providing the receiver with access to the selected versions of the sections of the initial item of software.

### RELATED APPLICATION DATA

This application is the National Stage of International Patent Application No. PCT/EP2012/055193, filed Mar. 23, 2012, the disclosure of which is hereby incorporated by reference in its entirety.

### FIELD OF THE INVENTION

The present invention relates to providing a receiver with a version of an initial item of software, and method, systems, computer programs and data structures for, or to enable, providing a receiver with a version of an initial item of software.

### BACKGROUND OF THE INVENTION

It is well-known for users (or their client devices or receiver devices) to be able to download software (for example from a server system) over a network. For example, there is an increasing infrastructure of downloadable software that is made available through, and that is downloadable from, a so-called “app-store” to various devices, such as mobile telephones, tablets, laptops, television sets, set top boxes, game consoles, personal computers, etc.

The term “software” as used herein may relate to one or more sequences of instructions designed for execution on a computer system, and may include a subroutine, a function, a procedure, an object method, an object implementation, an application, an applet, a servlet, source code, object code, machine or executable code, a shared library, a dynamic linked library, and/or other sequences of instructions designed for execution on a processor of a computer system.

A problem faced by the developers and distributors of software is that the software can be distributed in an unauthorised manner via unauthorised re-distribution platforms. This unauthorised dissemination is made particularly easy given the digital nature of the software and the ease with which exact copies of digital content can be made and subsequently communicated to others.

Digital watermarking of content is very well known. The content may comprise any type of digital data or digital signals, and may include one or more of audio data, image data, video data, textual data, multimedia data, a web page, software products, security keys, experimental data or any other kind of data. There are many methods for performing digital watermarking of content but, in general, they all involve adding a watermark to an item of content. This involves modifying or changing the original item of content to form a watermarked item of content—the modifications or changes made may represent payload data that is to be embedded in the item of content, or may simply be used to identify that particular watermarked item of content. The watermarked item of content can then be distributed to one or more users (or recipients or receivers).

Digital forensic watermarking, often referred to as fingerprint watermarking or simply fingerprinting, is increasingly being used to trace or identify a particular copy of content that had been provided to one (or more) users/receivers, to thereby identify those one (or more) users/receivers. This could be used, for example, to trace users who have “leaked” their content in an unauthorized manner (such as an unauthorized online distribution or publication of content). For this type of watermarking process, respective watermark codewords are assigned to each legitimate/authorized receiver/user. Each of the receivers/users receives, or is provided access to, a copy of the original item of content that has been modified in a manner that represents, or corresponds to, their respective watermark codeword. Then, if an unauthorized copy of the item of content is located, the watermark codeword can be decoded from that item of content and the receiver/user that corresponds to the decoded watermark codeword can be identified.

Software obfuscation is a known technology that can be used to increase the complexity of software and hence make reverse engineering of the software more difficult. A wide range of techniques are available to obscure execution flows and data flows in an item of software. For example, U.S. Pat. No. 7,395,433 (the entire disclosure of which is incorporated herein by reference) describes various methods to transform source code into an obfuscated version of the source code. European patent application EP2104987 (the entire disclosure of which is incorporated herein by reference) describes a fingerprint watermarking technique for software—in this method, one or more constructs that are used to obfuscate the software are replaced with respective different variants of those obfuscation constructs to produce a unique specific instance of an implementation of that software. Other software obfuscation and watermarking techniques are known and shall not, therefore, be described in detail herein—the particular details are not relevant to the discussion herein.

Existing fingerprint watermarking techniques are ill-suited to scenarios in which software is to be distributed, for example from a distribution server or an “app-store”. In particular, the processing overhead in watermarking an item of software (e.g. by inserting a unique watermark into an application) often involves a compile and linking step directed at a specific platform, and this is often too complex for the distribution server (in terms of processing requirements, the time required, and maintainability). Additionally, to increase security, obfuscation watermarking tool providers prefer to not make their tools available to external parties (such as distributors), as this exposes the tools to a larger population, potentially including one or more attackers.

### SUMMARY OF THE INVENTION

Given the above problems, it would be desirable to be able to be able to distribute software in a manner in which unauthorized copies and unauthorized distributions can be traced, whilst at the same time not imposing too large a processing overhead on the software distributors.

According to a first aspect of the invention, there is provided a method of providing a receiver with a version of an initial item of software, the method comprising: for each of a plurality of sections of the initial item of software that together form the initial item of software, obtaining one or more respective versions of that section, wherein for at least one of the sections a respective plurality of different versions of that section are obtained; for each of the plurality of sections of the initial item of software, selecting a respective version of that section to be used by the receiver, said selecting being arranged so that the receiver is identifiable from the set of selected versions; and providing the receiver with a version of the initial item of software by providing the receiver with access to the selected versions of the sections of the initial item of software.

In some embodiments, for each section of the initial item of software for which a respective plurality of different versions of that section are obtained, said respective plurality of different versions are differently watermarked versions of that section. However, other modification techniques may be used to obtain the different versions of a section.

In some embodiments, providing the receiver with access to the selected versions of the sections of the initial item of software comprises: forming said version of the initial item of software from the selected versions of the sections of the initial item of software; and communicating the formed version of the initial item of software to the receiver.

In some embodiments, providing the receiver with access to the selected versions of the sections of the initial item of software comprises: identifying to the receiver, for each of one or more of said selected versions of the sections of the initial item of software, a corresponding address from which the receiver can obtain that selected version. In such embodiments, for at least one version of a section of the initial item of software, obtaining said version of said section of the initial item of software may comprise obtaining an address from which the receiver can obtain that version of said section of the initial item of software.

In some embodiments, providing the receiver with access to the selected versions of the sections of the initial item of software comprises: forming a second item of software, said second item of software comprising: (a) for one or more of the plurality of sections of the initial item of software, including at least one of the at least one section for which a respective plurality of different versions of that section are obtained, an encrypted version of the or each version of that section, wherein for each of said at least one of the at least one section for which a respective plurality of different versions of that section are obtained the different versions of that section are encrypted differently from each other; and (b) for each of the sections of the initial item of software other than said one or more of the plurality of sections of the initial item of software, the respective selected version of that section; communicating the second item of software to the receiver; and providing the receiver with decryption data to enable the receiver to decrypt each selected version of a section of the initial item of software that is encrypted within the second item of software. In such embodiments, said obtaining may comprise either: (a) obtaining said encrypted versions; or (b) generated said encrypted versions by encrypting corresponding non-encrypted versions.

In some embodiments, said obtaining comprises obtaining a second item of software, said second item of software comprising: (a) for one or more of the plurality of sections of the initial item of software, including said at least one section for which a respective plurality of different versions of that section are obtained, an encrypted version of the or each version of that section, wherein for each of said at least one section for which a respective plurality of different versions of that section are obtained the different versions of that section are encrypted differently from each other; and (b) for each of the sections of the initial item of software other than said one or more of the plurality of sections of the initial item of software, the respective version of that section; and providing the receiver with access to the selected versions of the sections of the initial item of software comprises: communicating the second item of software to the receiver; and providing the receiver with decryption data to enable the receiver to decrypt each selected version of a section of the initial item of software that is encrypted within the second item of software.

In some embodiments, said obtaining comprises obtaining a second item of software, said second item of software comprising: (a) for one or more of the plurality of sections of the initial item of software, including said at least one section for which a respective plurality of different versions of that section are obtained, an encrypted version of the or each version of that section, wherein for each of said at least one section for which a respective plurality of different versions of that section are obtained the different versions of that section are encrypted differently from each other; and (b) for each of the sections of the initial item of software other than said one or more of the plurality of sections of the initial item of software, the respective version of that section; and providing the receiver with access to the selected versions of the sections of the initial item of software comprises: forming the version of the item of software from the second item of software by decrypting each selected version of a section of the initial item of software that is encrypted within the second item of software; and communicating the formed version of the item of software to the receiver.

In some embodiments, the second item of software comprises functionality to enable said decryption.

In some embodiments, two different versions are encrypted differently if they are encrypted using a different encryption key and/or a different encryption algorithm.

In some embodiments, said providing the receiver with access to the selected versions of the sections of the initial item of software is carried out in response to receiving a request from the receiver for a version of the initial item of software.

In some embodiments, said for each of the plurality of sections of the initial item of software, selecting a respective version of that section to be used by the receiver is carried out in response to receiving a request from the receiver for a version of the initial item of software.

In some embodiments, for each section of the initial item of software for which a respective plurality of different versions of that section are obtained, the different versions of that section are arranged such that versions of the initial item of software utilizing, respectively, the different versions of that section would generate the same output data when supplied with the same input data.

In some embodiments, the method comprises identifying the plurality of sections of the initial item of software that together form the initial item of software. In such embodiments, said obtaining may comprise, for each of said at least one of the sections, generating said plurality of different versions of that section.

In some embodiments, the version of the initial item of software provided to the receiver comprises a branching table to facilitate the control of process flow when the version of the initial item of software is executed by the receiver. The branching table may be generated, at least in part, by the second item of software.

According to a second aspect of the invention, there is provided a method for providing a receiver with a version of an initial item of software, the method comprising: identifying a plurality of sections of the initial item of software that together form the initial item of software; for at least one of the plurality of sections, generating a respective plurality of different versions of that section; and providing the generated versions of the at least one of the plurality of sections, together with any of the plurality of sections other than the at least one of the plurality of sections, to a software distribution system that is arranged to carry out a method according to any one of the preceding claims.

In some embodiments, said providing comprises providing the software distribution system with an address from which one of more of the generated versions of the at least one of the plurality of sections can be obtained by the receiver and/or from which one or more of any of the plurality of sections other than the at least one of the plurality of sections can be obtained by the receiver.

In some embodiments, said providing comprises: encrypting, for one or more of said at least one of the plurality of sections, said respective plurality of different versions of that section, wherein said respective plurality of different versions of that section are encrypted differently from each other; providing said encrypted versions to the software distribution system; and providing the software distribution system with decryption data to enable decryption of said encrypted versions.

In some embodiments, said providing comprises: forming a second item of software, said second item of software comprising: (a) for one or more of the plurality of sections of the initial item of software, including the at least one section for which a respective plurality of different versions of that section are generated, an encrypted version of the or each version of that section, wherein for each of said at least one section for which a respective plurality of different versions of that section are generated the different versions of that section are encrypted differently from each other; and (b) each of the sections of the initial item of software other than said one or more of the plurality of sections of the initial item of software; providing said second item of software to said software distribution system; and providing the software distribution system with decryption data to enable decryption of said encrypted versions.

According to a third aspect of the invention, there is provided a data structure corresponding to an initial item of software, the data structure comprising: for each of one or more of a plurality of sections of the initial item of software that together form the initial item of software, at least one encrypted version of that section, there being at least one section for which the data structure comprises a respective plurality of encrypted different versions of that section, the different versions of that section being encrypted differently from each other; and for each of the plurality of sections of the initial item of software other than said one or more of the plurality of sections of the initial item of software, a respective version of that section.

In some embodiments, the data structure further comprises decryption data to enable a recipient of the data structure to decrypt one or more encrypted versions of a section of the initial item of software within the data structure.

The data structure may be stored on a computer readable medium.

According to a fourth aspect of the invention, there is provided an apparatus comprising a processor and configured for said processor to carry out any one of the above-described methods.

According to a fifth aspect of the invention, there is provided a computer program which, when executed by a processor, causes the processor to carry out any one of the above-described methods. The computer program may be stored on a computer readable medium.

Thus, with embodiments of the invention, a software distributor (such as an app-store) can more easily generate fingerprinted versions of an item of software by providing a receiver with access to specific ones of different versions of sections of that item of software. The software distributor does not need to actually carry out any software obfuscation and/or watermark processing itself—all it needs to do is provide a receiver with access to the appropriate sections of software.

### BRIEF DESCRIPTION OF THE DRAWINGS

Embodiments of the invention will now be described, by way of example only, with reference to the accompanying drawings, in which:

FIG. 1 schematically illustrates an example system according to an embodiment of the invention, in which software fingerprint watermarking may be deployed;

FIG. 2 schematically illustrates an example of a computer system;

FIG. 3 schematically illustrates an item of software and processing performed on that item of software according to an embodiment of the invention;

FIG. 4 is a flowchart schematically illustrating a method according to an embodiment of the invention;

FIG. 5 is a flowchart schematically illustrating a method of providing a receiver with a copy or a version of an item of software according to an embodiment of the invention;

FIG. 6 is a flowchart schematically illustrating a particular method according to an embodiment of the invention for carrying the method of FIG. 5;

FIG. 7 schematically illustrates a version or copy of the item of software of FIG. 3 that may be formed according to one embodiment of the invention during the method of FIG. 6;

FIG. 8 is a flowchart schematically illustrating another method according to an embodiment of the invention for carrying the method of FIG. 5;

FIG. 9 is a flowchart schematically illustrating another method according to an embodiment of the invention for carrying the method of FIG. 5;

FIGS. 10a and 10b schematically illustrate versions or copies of the item of software of FIG. 3 that may be formed according to one embodiment of the invention during the method of FIG. 9; and

FIG. 11 schematically illustrates a combination of the examples shown in FIGS. 7 and 10a.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### System Overview

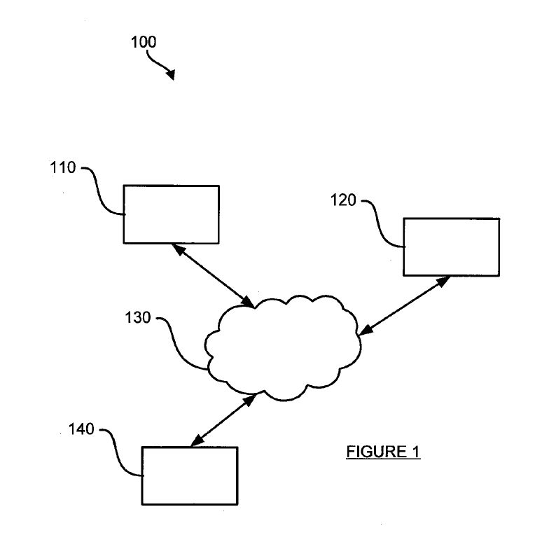

FIG. 1 schematically illustrates an example system 100 according to an embodiment of the invention, in which software fingerprint watermarking may be deployed. In particular, a software source 110 generates (or produces) an initial (or original) item of software, whilst a distributor 120 is arranged to distribute (or provide or supply) copies or versions of this item of software to one or more receivers 140.

The distributor 120 may be arranged to communicate with a receiver 140 over a network 130, so that the distributor 120 may provide a copy of, or a version of, the software to the receiver 140 over the network 130. In this case, the network 130 may be any kind of network suitable for transmitting or communicating the software copy from the distributor 120 to the receiver 140. For example, the network 130 could comprise one or more of a local area network, a wide area network, a metropolitan area network, the internet, a wireless communications network, a cable network, a digital broadcast network, a satellite communication network, a telephone network, etc. The distributor 120 may then communicate with a receiver 140 over the network 130 via any suitable communication mechanism/protocol in order to communicate data (such as the software copy and, if necessary, any other information required, such as conditional access data or digital rights management data) between the distributor 120 and the receiver 140. However, it will be appreciated that other communication scenarios are possible. For example, the distributor 120 may provide to a receiver 140 a physical medium (such as a CD, DVD, BluRay disc, etc.) storing the software copy, in which case the network 130 may be omitted.

In a similar manner, the software source 110 may be arranged to communicate with the distributor 120 over a network—in FIG. 1, this network is shown as being the same network 130 as used for communication between the distributor 120 and the receivers 140, but it will be appreciated that different networks could be used instead. The software source 110 may then communicate with the distributor 120 via any suitable communication mechanism/protocol in order to transfer data between the software source 110 and the distributor 120. Again, it will be appreciated that other communication scenarios are possible. For example, the software source 110 may provide to the distributor 120 a physical medium (such as a CD, DVD, BluRay disc, etc.) storing data, in which case the network 130 may be omitted.

Whilst FIG. 1 illustrates a single software source 110, a single distributor 120 and a single receiver 140, it will be appreciated that there may be multiple software sources 110 and/or multiple distributors 120 and/or multiple receivers 140 and that FIG. 1 has been simplified for the purposes of explanation.

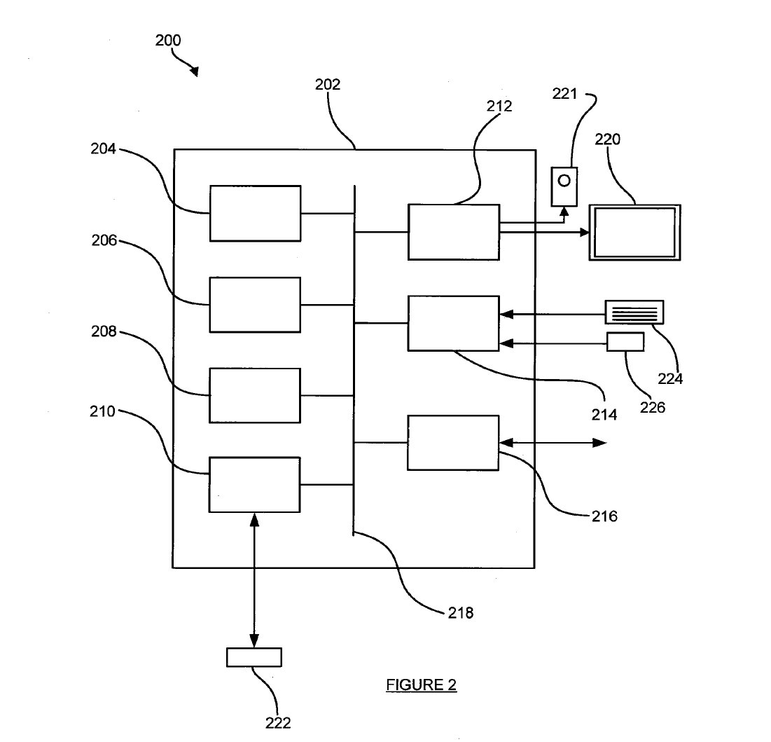

The software source 110, the distributor 120 and the receivers 140 may each comprise one or more computer systems 200. FIG. 2 schematically illustrates an example of such a computer system 200. The system 200 comprises a computer 202. The computer 202 comprises: a storage medium 204, a memory 206, a processor 208, a storage medium interface 210, a user output interface 212, a user input interface 214 and a network interface 216, which are all linked together over one or more communication buses 218.

The storage medium 204 may be any form of non-volatile data storage device such as one or more of a hard disk drive, a magnetic disc, an optical disc, a ROM, etc. The storage medium 204 may store an operating system for the processor 208 to execute in order for the computer 202 to function. The storage medium 204 may also store one or more computer programs (or software or instructions or code) that form part of an embodiment of the invention.

The memory 206 may be any random access memory (storage unit or volatile storage medium) suitable for storing data and/or computer programs (or software or instructions or code).

The processor 208 may be any data processing unit suitable for executing one or more computer programs (such as those stored on the storage medium 204 and/or in the memory 206), some of which may be computer programs according to embodiments of the invention or computer programs that, when executed by the processor 208, cause the processor 208 to carry out a method according to an embodiment of the invention and configure the system 200 to be a system according to an embodiment of the invention. The processor 208 may comprise a single data processing unit or multiple data processing units operating in parallel or in cooperation with each other. The processor 208, in carrying out data processing operations for embodiments of the invention, may store data to and/or read data from the storage medium 204 and/or the memory 206.

The storage medium interface 210 may be any unit for providing an interface to a data storage device 222 external to, or removable from, the computer 202. The data storage device 222 may be, for example, one or more of an optical disc, a magnetic disc, a solid-state-storage device, etc. The storage medium interface 210 may therefore read data from, or write data to, the data storage device 222 in accordance with one or more commands that it receives from the processor 208.

The user input interface 214 is arranged to receive input from a user, or operator, of the system 200. The user may provide this input via one or more input devices of the system 200, such as a mouse (or other pointing device) 226 and/or a keyboard 224, that are connected to, or in communication with, the user input interface 214. However, it will be appreciated that the user may provide input to the computer 202 via one or more additional or alternative input devices (such as a touch screen). The computer 202 may store the input received from the input devices via the user input interface 214 in the memory 206 for the processor 208 to subsequently access and process, or may pass it straight to the processor 208, so that the processor 208 can respond to the user input accordingly.

The user output interface 212 is arranged to provide a graphical/visual and/or audio output to a user, or operator, of the system 200. As such, the processor 208 may be arranged to instruct the user output interface 212 to form an image/video signal representing a desired graphical output, and to provide this signal to a monitor (or screen or display unit) 220 of the system 200 that is connected to the user output interface 212. Additionally or alternatively, the processor 208 may be arranged to instruct the user output interface 212 to form an audio signal representing a desired audio output, and to provide this signal to one or more speakers 221 of the system 200 that is connected to the user output interface 212.

Finally, the network interface 216 provides functionality for the computer 202 to download data from and/or upload data to one or more data communication networks (such as the network 130 of FIG. 1).

It will be appreciated that the architecture of the system 200 illustrated in FIG. 2 and described above is merely exemplary and that other computer systems 200 with different architectures (for example with fewer components than shown in FIG. 2 or with additional and/or alternative components than shown in FIG. 2) may be used in embodiments of the invention. It will also be appreciated that the content source 110, the distributor 120 and the receivers 140 may use different kinds of computer system 200. As examples: the or each computer system 200 for the content source 110 may be a personal computer or a server computer; the or each computer system 200 for the distributor 120 may be a personal computer or a server computer; and the or each computer system 200 for the or each receiver 140 may be one or more of a mobile telephone, a tablet, a laptop, a television set, a set top box, a games console, a personal computer, a server computer, other mobile devices or consumer electronics devices, etc.

In some embodiments of the invention, the content source 110 and the distributor 120 may be a single integrated system—in such embodiments, the separation of functionality and processing between the content source 110 and the distributor 120 is purely conceptual and is presented herein merely for ease of explanation.

### Fingerprint Watermarking

Embodiments of the invention may make use of software watermarking. Various software watermarking techniques are known to exist and the particular method by which an item of software is watermarked is not important for embodiments of the invention. For example, as mentioned above, software obfuscation is a known technology that can be used to increase the robustness of the software and hence make reverse engineering more difficult. A wide range of techniques are available to obscure execution flows and data flows in an item of software—U.S. Pat. No. 7,395,433 describes various methods to transform source code into an obfuscated version of the source code. European patent application EP2104987 describes a fingerprint watermarking technique for software—in this method, one or more constructs that are used to obfuscate the software are replaced with different variants of those obfuscation constructs to produce a unique specific instance of an implementation of that software. Embodiments of the invention may make use of the watermarking techniques described in U.S. Pat. No. 7,395,433 and EP2104987, but it will be appreciated that other software obfuscation and watermarking techniques are known and may be used in embodiments of the invention instead. Some software watermarking techniques operate on source code; some software watermarking techniques operate on compiled source code, i.e. on object code; and some software watermarking techniques operate on bound/linked object code, i.e. on executable code (or machine code). Embodiments of the invention may make use of any of these kinds of watermarking techniques.

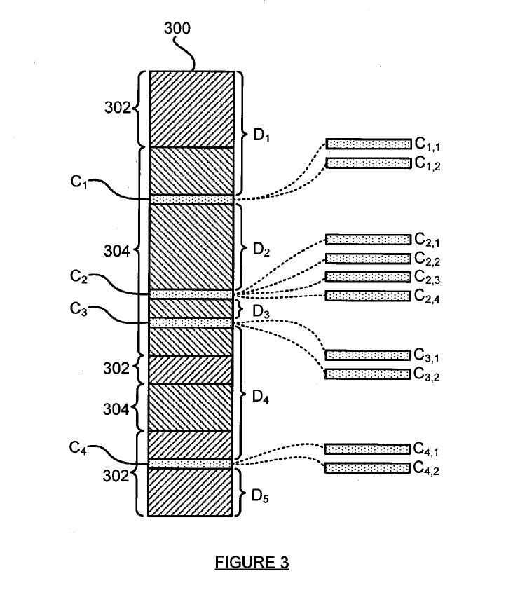

FIG. 3 schematically illustrates an item of software 300 and processing performed on that item of software 300 according to an embodiment of the invention. As mentioned above, the item of software 300 may comprise one or more sequences of instructions designed for execution on a computer system (such as a receiver 140), and may include a subroutine, a function, a procedure, an object method, an object implementation, an application, an applet, a servlet, source code, object code, machine or executable code, a shared library, a dynamic linked library, and/or other sequences of instructions designed for execution on a processor of a computer system. The item of software 300 may also include various amounts of data (such as static/constant values, look-up tables, etc.)

Some or all of the item of software 300 may be protected via one or more software obfuscation techniques (such as those set out in U.S. Pat. No. 7,395,433 and EP2104987). FIG. 3 illustrates portions 302 of the item of software 300 that have not been protected via one or more software obfuscation techniques and portions 304 of the item of software 300 that have been protected via one or more software obfuscation techniques. The software obfuscation techniques might not be applicable to certain parts of the item of software 300, which is why there may be one or more portions 302 of the item of software 300 that have not been protected via one or more software obfuscation techniques. It will be appreciated, though, that for some items of software 300 there may be no portions 302 of the item of software 300 that have not been protected via one or more software obfuscation techniques—i.e. the whole item of software 300 may be protected via software obfuscation techniques.

The use of software obfuscation techniques to generate the item of software 300 is, however, not essential to the invention (so that there may be no portions 304 of the item of software 300 that have been protected via one or more software obfuscation techniques), although the code redundancy produced by software obfuscation may help in watermarking processes and the additional protection produced by software obfuscation also helps increase the security of the software. Some software watermarking techniques, however, operate on, or work in conjunction with, obfuscated software and, in embodiments that utilise such a software watermarking technique, the item of software 300 will need at least one portion 304 that has been protected via one or more software obfuscation techniques. For example, a software watermarking technique may generate a watermarked version of an item of software by changing (or modifying or replacing) one or more encoding functions or obfuscation functions that are used to encode data as part of the obfuscation technique (see, for example, the watermarking technique set out in EP2104987).

Any particular software watermarking technique will operate on a particular suitable amount (or unit or portion or part or section) of the software, perhaps of a particular type. In particular, a software watermarking technique may function by modifying an amount of software that is of a particular type, such as one or more of: static/constant data within the item of software 300 (for example lookup-tables, constant values, etc.); instructions relating to flow control or data flow within a function; functions used to encode or obfuscate data values; etc. A software watermarking technique may function by modifying a minimum or specific amount (or a unit or portion or part or section) of the software. For example, the software watermarking may operate by modifying one or more instructions in isolation of other instructions (in which case the minimum/specific amount is at the instruction-level); the software watermarking may operate by modifying a function or procedure in isolation of another function or procedure (in which case the minimum/specific amount is at the function-level); the software watermarking may operate by modifying one static/constant data value in isolation of another static/constant data value (in which case the minimum/specific amount is at the level of a static/constant data value); the software watermarking may operate by modifying one block of data values (e.g. a look-up table) in isolation of another block of data values (e.g. another look-up table) (in which case the minimum/specific amount is at the level of a block of data values such as a look-up table); etc.

Embodiments of the invention involve identifying and selecting one or more sections Cᵢ (or parts or chunks or units or portions or amounts) of the item of software 300 that are suitable for the particular software watermarking technique that is to be used, i.e. each section Cᵢ is of a suitable type and/or is of an amount/size so that the watermarking technique can operate on, or be applied to, that section Cᵢ to produce a watermarked, or modified, version of that section Cᵢ. For example, the watermarking technique set out in EP2104987 operates by changing (or modifying or replacing) one or more encoding functions that are used in the obfuscation of the software—in this case, the suitable sections Cᵢ of the item of software 300 may each correspond to, or at least contain, a respective encoding function. As another example, for a watermarking technique that operates by modifying a look-up table, the suitable sections Cᵢ of the item of software 300 may be identified as, or at least may contain, one or more look-up tables in the item of software 300. A section Cᵢ need not necessarily be just a minimum amount of the item of software 300 to which the watermarking technique that is to be used may be applied—the section Cᵢ may comprise an additional amount of the item of software 300. For example, some or all of the item of software 300 (such as the portions 304) may be divided into a number of sections (potentially of equal size), and each of these sections may be tested to see whether it is suitable for being watermarked by the watermarking technique that is to be used—if it is suitable, then it may be selected to be one of the selected sections Cᵢ.

In FIG. 3, there are four suitable sections C₁, C₂, C₃ and C₄, but it will be appreciated that this is purely exemplary and, in practice, the number of suitable sections Cᵢ identified and selected may be limited by the number of sections of the item of software 300 that are actually suitable for the watermarking technique being adopted. Additionally, an upper bound may be placed on the number of sections Cᵢ that are to be selected, as only a predetermined maximum number T may be needed—thus, if more than the predetermined maximum number T of suitable sections are identified in the item of software 300, then embodiments of the invention may select only the threshold maximum number T out of all of those identified suitable sections (for example: as a random selection; or a selection that attempts to ensure that the selected sections are evenly distributed across the item of software 300; or the selection of the first, middle, or last T suitable sections; etc.).

FIG. 3 illustrates three of the sections C₁, C₂ and C₃ being in portions 304 of the item of software 300 that have been protected via one or more software obfuscation techniques and one section C₄ in a portion 302 of the item of software 300 that has not been protected via one or more software obfuscation techniques, but it will be appreciated that this is merely exemplary. If the watermarking technique only operates on portions 304 of the item of software 300 that have been protected via one or more software obfuscation techniques, then all of the sections Cᵢ will be located within portions 304 of the item of software 300 that have been protected via one or more software obfuscation techniques; if the watermarking technique does not need to operate on portions 304 of the item of software 300 that have been protected via one or more software obfuscation techniques, then some or all of the sections Cᵢ may be located in portions 302 of the item of software 300 that have not been protected via one or more software obfuscation techniques. Indeed, part of a section Cᵢ could be in a portion 302 of the item of software 300 that has not been protected via one or more software obfuscation techniques whilst another part of that section Cᵢ could be in a portion 304 of the item of software 300 that has been protected via one or more software obfuscation techniques.

Although the sections Cᵢ are illustrated in FIG. 3 as being contiguous portions of the item of software 300, this need not be the case. For example, a particular watermarking technique may involve modifying a function that encodes an amount of data (e.g. an input value) and also modifying a function that performs a decoding operation (e.g. as an inverse of the encoding operation) after the encoded amount of data has been processed—the encoding and decoding functions may be spaced apart within the item of software 300 but, together, may be considered, and handled, as a single suitable section Cᵢ of the item of software 300.

Although FIG. 3 illustrates the item of software 300 as being a single “file” (or a continuous amount) of software, embodiments of the invention may operate when the item of software 300 comprises a plurality of files (such as a main program file and/or one or more configuration files and/or one or dynamic link libraries, etc.). In this case, the set of sections Cᵢ may be distributed across multiple files. Indeed, a single (fragmented) section Cᵢ may be distributed across multiple files.

In FIG. 3, the item of software 300 less the selected sections Cᵢ comprises five other sections D₁, D₂, D₃, D₄ and D₅. This could, alternatively, be views as a single “other” (non-contiguous) section D (the union/combination of D₁, D₂, D₃, D₄ and D₅). This section D shall be referred to below as the “residual section” D.

For each of the selected sections Cᵢ, embodiments of the invention involve forming a respective plurality of different versions of that section Cᵢ, for example by modifying or watermarking the sections Cᵢ to form respective differently modified or watermarked versions of the sections Cᵢ. For the sake of generality, assume that the number of selected suitable sections Cᵢ is N and, for each selected section Cᵢ (i=1, . . . , N), let the number of versions formed for the section Cᵢ be Mᵢ (where Mᵢ>1), then the j-th version (j=1, . . . , Mᵢ) for the section Cᵢ shall be represented as C_{i,j}. Thus, a section Cᵢ may be modified or watermarked in Mᵢ different ways, so that each respective version C_{i,j} represents, or possibly has embedded therein, one of Mᵢ different codewords or values, e.g. values 0,1, . . . , (Mᵢ−1). The value of Mᵢ may be the same for all selected sections Cᵢ, (for example, Mᵢ may equal 2 for all selected sections Cᵢ); however, this is not essential, as shown in FIG. 3 (where M₁=M₃=M₄=2 but M₂=4).

Preferably, the different versions of each selected suitable section Cᵢ are generated such that using one version of the selected section would produce the same result as using another version of that selected section. In other words, for each section Cᵢ, the different versions C_{i,j} of that section Cᵢ are preferably arranged such that versions of the initial item of software 300 utilizing, respectively, the different versions C_{i,j} of that section Cᵢ (in place of that section Cᵢ) would generate the same output data when supplied with the same input data. In other words, the different versions C_{i,j} may all perform the same overall function/purpose, but may achieve this overall function/purpose in different ways. The watermarking techniques set out in EP2104987 provide examples of a modification technique that achieves this.

In some embodiments of the invention, the receiver 140 (or target platform) may execute an interpreter for interpreting source code in order to execute an item of software (instead of executing compiled code). For example, an item of software could be written in a language such as Visual Basic, which is an interpreted language. In such embodiments, the item of software 300 is source code and embodiments of the invention operate on source code. Thus, the various different versions C_{i,j} of each selected section Cᵢ are different sections of source code.

For other embodiments of the invention, the intention may be to provide the receiver 140 with compiled software. For embodiments of the invention that operate on executable code (i.e. when the item of software 300 is already at the machine code level and the watermarking techniques operate on machine code), then the versions C_{i,j} of each selected suitable section Cᵢ (i=1, . . . , N, j=1, . . . , Mᵢ) and, if it exists, the residual section D too are already in executable code form. However, for embodiments of the invention that do not operate on executable code, the versions C_{i,j} will not initially be executable code, so further processing is carried out to form versions C_{i,j} in executable code form i.e. to convert each “intermediate” version C_{i,j} into a corresponding “final” machine code version C_{i,j}. In particular, for embodiments of the invention that operate on source code (i.e. when the item of software 300 is at the source code level and the watermarking techniques operate on source code), corresponding executable/machine code is generated (by compilation and linking/binding as necessary for a target platform) for each of the versions C_{i,j} of each selected suitable section Cᵢ (i=1, . . . , N, j=1, . . . , Mᵢ) and, if it exists, for the residual section D. This could be achieved, for example, by using a section C_{i,j} in the item of software 300 in place of the corresponding original section Cᵢ and then compiling and linking/binding the item of software 300. The part of the resulting executable code that corresponds to the section C_{i,j} can then be identified (for example by looking for the location of corresponding function entry and exit points or the location of look-up tables, etc. depending on the nature of the watermarking technique)—this identified part is then used as the corresponding “final” machine code version C_{i,j}. The same applies analogously to the residual section D (or it subparts Dᵢ). For embodiments of the invention that operate on object code (i.e. when the item of software 300 is at the object code level and the watermarking techniques operate on object code), corresponding executable code is generated (by linking/binding as necessary for a target platform) for each of the versions C_{i,j} of each selected suitable section Cᵢ (i=1, . . . , N, j=1, . . . , Mᵢ) and, if it exists, for the residual section D. This could be achieved in an analogous manner to that set out above for source code.

Thus, for embodiments of the invention in which the item of software 300 is intended to be run by an interpreter on a receiver 140, the versions C_{i,j} generated for each selected suitable section Cᵢ (i=1, . . . , N, j=1, . . . , Mᵢ) are differently modified portions of source code corresponding to that section Cᵢ. For embodiments of the invention in which the item of software 300 is intended to be run on a receiver 140 as executable/machine code, the versions C_{i,j} generated for each selected suitable section Cᵢ (i=1, . . . , N, j=1, . . . , Mᵢ) are differently modified portions of machine code corresponding to that section Cᵢ—in these cases, compiling and link/binding steps might be required (as set out above), depending on the form (source code, object code or machine code) of the initial item of software 300 and the type of code on which the watermarking techniques may operate.

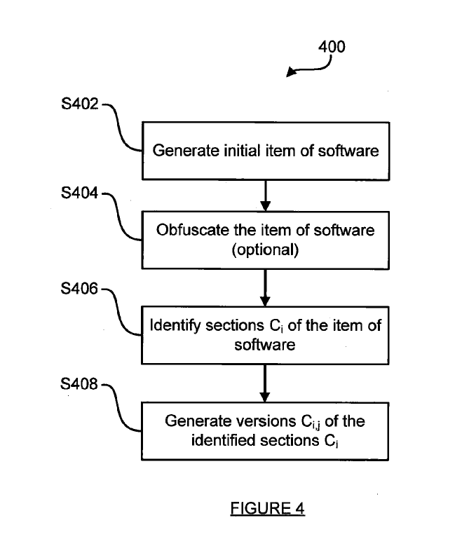

FIG. 4 is a flowchart schematically illustrating a method 400 according to an embodiment of the invention. This method 400 may be carried out, for example, by the content source 110.

At a step S402, an initial item of software 300 is generated. For example, as it well-known in this field of technology, one or more software engineers/designers may code-up and create an item of software 300. The item of software 300 may be in source code form, object code form, or machine code form (the choice depending on the nature of, and being suitable for, steps S404 and S406 set out below).

At the step S404, one or more software obfuscation techniques are applied to the initial item of software 300 to generate an obfuscated item of software 300. As mentioned above, such software obfuscation techniques are well-known in this field of technology and therefore shall not be described in detail herein.

At the step S406, one or more of sections of the item of software 300 are identified, each of the plurality of sections being suitable for the application of a modification process, such as a software watermarking process. As mentioned above, such software watermarking processes are well-known in this field of technology, and the identification of an amount of software suitable for being watermarked (in order to be able to apply the watermarking process) is also well-known—they shall, therefore, not be described in detail herein. A number of the identified sections are selected for further use—this may involve selecting all of the identified sections or selecting a predetermined number of the identified sections, or some other selection criteria. Thus, the step S406 results in a plurality of sections Cᵢ of the item of software 300 being identified and selected.

Note that, if the watermarking technique that is to be used does not rely on the item of software 300 having obfuscated portions 304, then the step S404 may be omitted.

At a step S408, for each of the selected sections Cᵢ, a plurality of different versions of that section Cᵢ are generated, for example by using the watermarking process to generate differently watermarked versions C_{i,j} of that section Cᵢ. As set out above, it may be necessary to convert the differently watermarked versions C_{i,j} (and, if it exists, the residual section D too) into machine code, depending on the initial form of the item of software 300 and the nature of the target platform, i.e. whether or not the receiver 140 will be interpreting source code or executing machine code.

Thus, at the end of the step S408, the initial item of software 300 (or the obfuscated item of software 300 if the step S404 is used) may be viewed as being formed from a plurality of separate (non-overlapping) sections (Cᵢ for i=1, . . . , N and, if present, the residual section D), each of these sections having one or more respective versions of that section, at least one of the sections (namely the selected sections Cᵢ for i=1, . . . , N) having a respective plurality of different versions (namely the versions C_{i,j} for i=1, . . . , N and j=1, . . . , Mᵢ) of that section.

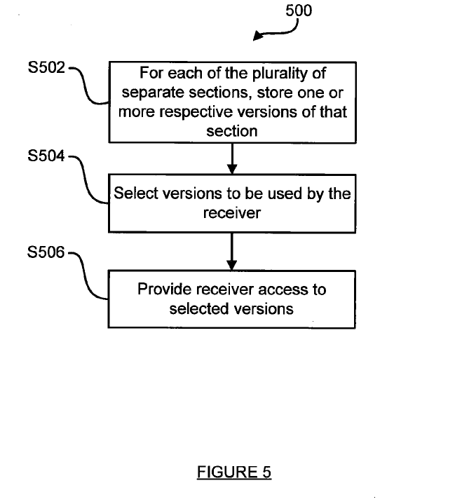

FIG. 5 is a flowchart schematically illustrating a method 500 of providing a receiver 140 with a copy or a version of an item of software 300 according to an embodiment of the invention. This method 500 may be carried out by the distributor 120.

At a step S502, for each of the plurality of separate sections that form the item of software 300 (namely sections C₁, . . . , C_{N}, and D if present), one or more respective versions of that section are obtained (and possibly stored, for example in a memory or a database). In particular, for each of the sections C₁, . . . , C_{N}, the respective plurality of different versions C_{i,1}, . . . , C_{i,M}_{ᵢ} (i=1, . . . , N) are obtained; for the residual section D (if it is present), or its subparts D₁, D₂, . . . , there is only one version of that section and hence only the initial version of the residual section D (or its subparts D₁, D₂, . . . ) is obtained. These sections may be provided to, and obtained by, the distributor 120 from the software source 110.

The receiver 140 is be provided with a copy of the item of software 300 formed from the versions C_{i,j} of each selected section Cᵢ (i=1, . . . , N and j=1, . . . , Mᵢ) and, if it exists, the residual section D too. Thus, at a step S504, for a particular receiver 140, for each section Cᵢ (i=1, . . . , N) an index vᵢ is chosen in the range 1≦vᵢ≦Mᵢ so that the sequence of indices (v₁,v₂, . . . , v_{N}) identifies that receiver 140. For example, for each receiver 140 that is to be provided with a copy of the item of software 300, a sequence of indices (v₁,v₂, . . . , v_{N}) unique to (or particular to or corresponding to) that receiver 140 may be generated. Each index vᵢ (i=1, . . . , N) may be seen as a symbol in the range (or alphabet) 1≦vᵢ≦Mᵢ, with the sequence of indices (v₁,v₂, . . . , v_{N}) then being a fingerprint codeword associated with the receiver 140—there are then numerous ways of selecting suitable sequences of indices (v₁,v₂, . . . , v_{N}) to act as a fingerprint codeword for the receiver 140, as are well-known in this field of technology. The sequence of indices (v₁,v₂, . . . , v_{N}) may be selected in whole or in part by the distributor 120 and/or the software source 110 and/or some other third party (i.e. an alternative source). The sequence of indices (v₁,v₂, . . . , v_{N}) may have redundancy at the sequence level, in that a particular receiver 140 can still be identified even if some of the indices in the sequence of indices (v₁,v₂, . . . , v_{N}) are omitted or are changed/corrupted (e.g. if a “suspect” version of the software is found, but that “suspect” version has been tampered with or is only partially complete).

Thus, for each of the plurality of sections of the item of software (namely sections C₁, . . . , C_{N}, and D if present), a respective version of that section is selected for the receiver 140. Of course, for sections (such as the residual section D, or its individual parts D₁, D₂, . . . depending on one's viewpoint) for which there is only one version, the selected version is the original version. For sections Cᵢ, the selected version for that section is C_{i,v}_{ᵢ}. The set of selected versions (namely C_{1,v}_{₁}, . . . , C_{N,v}_{_{N}}, and D if present) can be used to identify the corresponding receiver 140. In particular, this set of selected versions corresponds to the sequences of indices (v₁,v₂, . . . , v_{N}) associated with (or assigned to) the receiver 140. For example, upon receiving a “suspect” version of an item of software, a watermark decoding operation may be performed on each of the corresponding selected sections Cᵢ from that suspect version—the watermark decoding operation would reveal that the suspect version contains the vᵢ-th version C_{i,v}_{ᵢ} of the i-th selected section Cᵢ (for i=1, . . . , N), so that the sequence (v₁,v₂, . . . , v_{N}) is obtained from the suspect version, thereby identifying the corresponding initial receiver 140. The distributor 120 (or another entity, such as a trusted third party) may store the sequence (v₁,v₂, . . . , v_{N}) in association with an identification of the corresponding receiver 140 so that the receiver 140 can be subsequently identified if the sequence (v₁,v₂, . . . , v_{N}) is decoded from a suspect version of an item of software.

At a step S506, the receiver 140 is provided with a copy or a version of the item of software 300 by providing the receiver 140 with access to the versions of the sections of the item of software 300 that have been selected for that receiver 140, namely C_{1,v}_{₁}, . . . , C_{N,v}_{_{N}}, and D if present.

Thus, the number of different versions of the item of software 300 that can be produced is

$${\prod }_{i = 1}^{N} {M}_{i} .$$

Thus, the value of N and the value of each Mᵢ can be chosen to be sufficiently large so that the entire population of receivers 140 (or at least the number of receivers 140 expected to be provided with a version of the item of software 300) can all be provided with their own specific version of the item of software 300.

The method 500 may be carried out in numerous ways, as set out below.

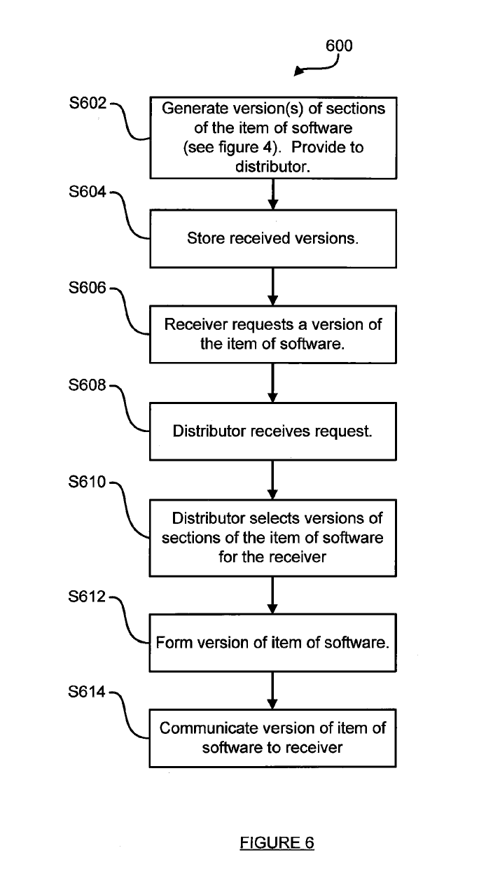

FIG. 6 is a flowchart schematically illustrating a particular method 600 according to an embodiment of the invention for carrying the method 500 of FIG. 5.

At a step S602, the software source 110 carries out the method 400 described above with reference to FIG. 4. The software source 110 provides all of the generated versions of the sections of the item of software 300 (namely the versions C_{i,j} i=1, . . . , N and j=1, . . . , Mᵢ, and D if present) to the distributor 120.

At a step S604, the distributor 120 stores the received versions, for example in a database.

At a step S606, the receiver 140 sends a request to the distributor 120 requesting a copy or a version of the item of software 300.

At a step S608, the distributor 120 receives the request.

At a step S610, the distributor 120 carries out the step S504 of FIG. 5 to select, for each of the plurality of sections Cᵢ (and possibly D if present) of the item of software 300, a respective version of that section (namely C_{1,v}_{₁}, . . . , C_{N,v}_{_{N}}, and D if present) to be used by the receiver 140, this selection being arranged so that the receiver 140 from which the request was received is identifiable from the set of selected versions.

At a step S612, the distributor 120 forms a version of the item of software 300 from the selected versions (namely C_{1,v}_{₁}, . . . , C_{N,v}_{_{N}}, and D if present) of the sections of the item of software 300.

At a step S614, the distributor 120 communicates (or transmits or provides) the version of the item of software formed at the step S612 to the receiver 140.

Whilst the step S610 is illustrated as being performed in response to the distributor 120 receiving the request from the receiver 140, it will be appreciated that the step S610 may be carried out without having to receive a request from the receiver 140 (e.g. in anticipation of receiving the receiver's request 140). Thus, the step S610 may be carried out prior to the steps S606 and S608. Moreover, in some embodiments of the invention, the steps S606 and S608 may be omitted, for example in embodiments in which the distributor 120 provides automatic software downloads (e.g. software updates) to receivers 140.

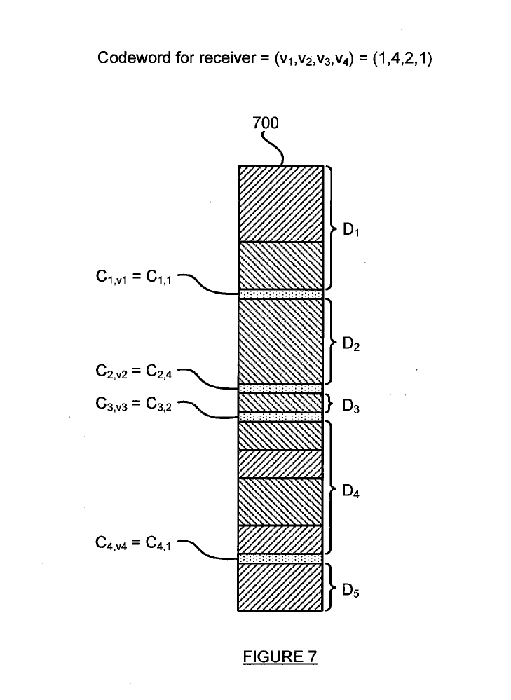

FIG. 7 schematically illustrates a version or copy 700 of the item of software 300 that may be formed at the step S612 according to one embodiment of the invention. This example is based on the example item of software 300 illustrated in FIG. 3, and for which the selected sequence of versions is, for example, (v₁,v₂,v₃,v₄)=(1,4,2,1).

In FIG. 7, the version 700 of the item of software 300 is formed by concatenating the selected versions of the sections of the item of software 300 (in the order corresponding to the original sections C₁, . . . , C_{N} and D₁,D₂, . . . if present). The residual section D may be viewed as a template into which the different versions C_{1,v}_{₁}, . . . , C_{N,v}_{_{N}} may be inserted.

However, in some embodiments, (such as where the versions C_{1,v}_{₁}, . . . , C_{N,v}_{_{N}} relate to different functions or procedures), the ordering of the versions C_{1,v}_{₁}, . . . , C_{N,v}_{_{N}} within the version 700 may be changed (for instance when it makes no difference whether function A appears before function B or after function B within the version 700). This may apply, for example, when the versions C_{1,v}_{₁}, . . . , C_{N,v}_{_{N}} are source code to be interpreted by an interpreter running on the receiver 140.

In some embodiments, the selected versions may be stored and provided as one or more separate files, so that the single file format shown in FIG. 7 need not be used. In this case, the distributor 120 may combine the files containing the selected versions as a suitable download package for delivery to the receiver 140. For example, each version C_{1,v}_{₁}, . . . , C_{N,v}_{_{N}} may be in its own respective DLL file, so that the distributor 120 could then provide a main program file (e.g. representing the residual section D) together with a set of DLLs for the versions C_{1,v}_{₁}, . . . , C_{N,v}_{_{N}}.

It will be appreciated that the distributor 120 may form the version of the item of software 300 at the step S612 in other ways as appropriate, depending on the particular form of the versions of the sections of the item of software 300 that it has obtained (from the software source 110).

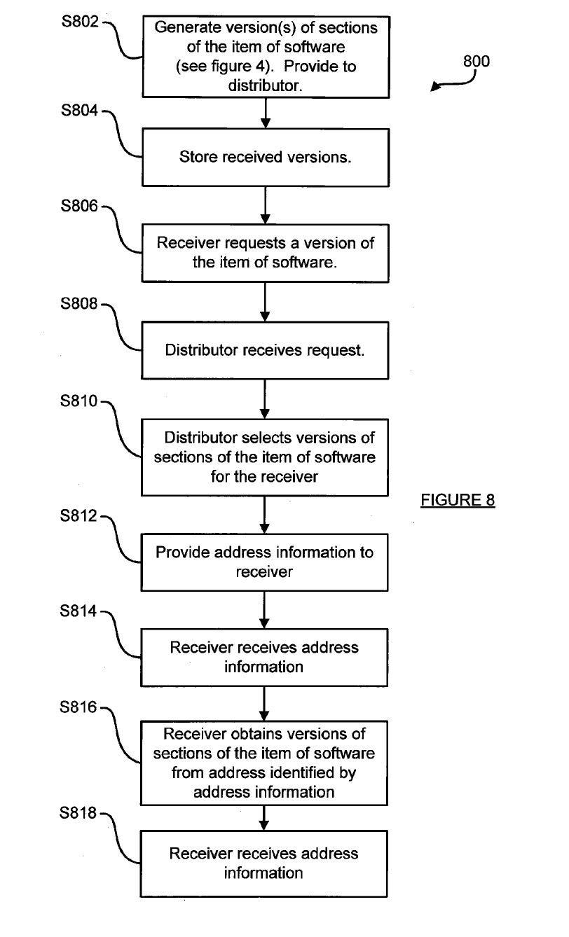

FIG. 8 is a flowchart schematically illustrating another method 800 according to an embodiment of the invention for carrying the method 500 of FIG. 5.

At a step S802, the software source 110 carries out the method 400 described above with reference to FIG. 4. The software source 110 provides all of the generated versions of the sections of the item of software 300 (namely the versions C_{i,j} i=1, . . . , N and j=1, . . . , Mᵢ, and D if present) to the distributor 120.

At a step S804, the distributor 120 stores the received versions, for example in a database.

At a step S806, the receiver 140 sends a request to the distributor 120 requesting a copy or a version of the item of software 300.

At a step S808, the distributor 120 receives the request.

At a step S810, the distributor 120 carries out the step S504 of FIG. 5 to select, for each of the plurality of sections Cᵢ (and possibly D if present) of the item of software 300, a respective version of that section (namely C_{1,v}_{₁}, . . . , C_{N,v}_{_{N}}, and D if present) to be used by the receiver 140, this selection being arranged so that the receiver 140 from which the request was received is identifiable from the set of selected versions.

At a step S812, the distributor 120 identifies to the receiver 140, for one or more of the selected versions of the sections (namely C_{1,v}_{₁}, . . . , C_{N,v}_{_{N}}, and D if present) of the item of software 300, a corresponding address from which the receiver 140 can obtain (or download or access) that selected version. The address may be provided, for example, as a URL or URI or any other kind of address/location/reference information identifying a location at which the respective selected version of the section of the item of software 300 may be downloaded. The various sections C_{i,j} may be located within a single file at the distributor 120, in which case the address for a section C_{i,j} may identify an offset (e.g. from the beginning of the file) and possibly a length value identifying the size of the section C_{i,j} (if this is not already known to the receiver 140) so that the corresponding section C_{i,j} can be identified within that single file—the offset and length values may be contained, for example, within a URL as fields of that URL, the URL identifying the file. It will be appreciated that other mechanisms for identifying an address may be used. In addition to communicating the address information to the receiver 140, the distributor 120 may communicate to the receiver 140 any selected versions of the sections of the item of software 300 for which such address information is not provided to the receiver 140. There may be a single address applicable to all of the selected versions that are provided with an address. Alternatively, each version that is provided with an address may have its own respective address—in this way the distributor 120 may provide a sequence or set of addresses (which could be viewed as a playlist of addresses). The receiver 140 may be provided with data from which the receiver 140 can generate the/each address (as opposed to the receiver 140 being explicitly provided with the actual addresses).

At a step S814, the receiver 140 receives the address information (possibly together with one or more selected versions of the sections of the item of software 300 for which such address information is not provided to the receiver 140).

At a step S816, the receiver 140 obtains (or downloads or accesses) the selected versions of sections of the item of software 300 for which respective address information has been provided to the receiver 140. In particular, for each selected version of a section of the item of software 300 for which address information has been provided to the receiver 140, the receiver 140 downloads (or accesses or otherwise obtains) that selected version from the location identified by the address information.

At a step S818, the receiver 140 uses the selected versions of sections of the item of software 300 obtained at the step S816 (and possibly also at the step S814) to form the version of the item of software 300 intended for that receiver 140. This may be performed in the manner described above with reference to the step S612 of FIG. 6. The distributor 120 may provide the receiver 140 with (or provide access to) a computer program that is configured to form the version of the item of software 300 intended for the receiver 140 from the versions of sections of the item of software 300 that the receiver 140 has obtained.

Whilst the step S810 is illustrated as being performed in response to the distributor 120 receiving the request from the receiver 140, it will be appreciated that the step S810 may be carried out without having to receive a request from the receiver 140 (e.g. in anticipation of receiving the receiver's request 140). Thus, the step S810 may be carried out prior to the steps S806 and S808. Moreover, in some embodiments of the invention, the steps S806 and S808 may be omitted, for example in embodiments in which the distributor 120 provides automatic software downloads (e.g. software updates) to receivers 140.

In some embodiments, instead of the software source 110 providing all of the generated versions of the sections of the item of software 300 (namely the versions C_{i,j} i=1, . . . , N and j=1, . . . , Mᵢ, and D if present) to the distributor 120 at the steps S802 and S804, the steps S802 and S804 could involve the software source 110 providing address information for some or all of the generated versions of the sections of the item of software 300 (namely some or all of the versions C_{i,j} i=1, . . . , N and j=1, . . . , Mᵢ, and D if present) to the distributor 120, i.e. the distributor need not necessarily store the generated versions of the sections of the item of software 300 and, instead, some or all of them could be stored at another location (which could even be the software source 110 itself). Indeed, any software distribution infrastructure could be used for this, such as peer-to-peer networks.

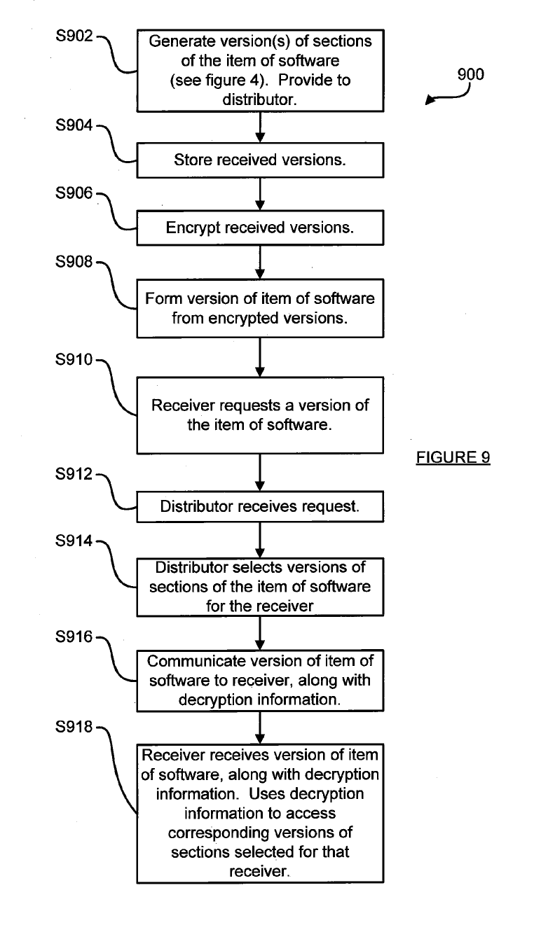

FIG. 9 is a flowchart schematically illustrating another method 900 according to an embodiment of the invention for carrying the method 500 of FIG. 5.

At a step S902, the software source 110 carries out the method 400 described above with reference to FIG. 4. The software source 110 provides all of the generated versions of the sections of the item of software 300 (namely the versions C_{i,j} i=1, . . . , N and j=1, . . . , Mᵢ, and D if present) to the distributor 120.

At a step S904, the distributor 120 stores the received versions, for example in a database.

At a step S906, the distributor 120 encrypts each of the versions C_{i,j} of those sections Cᵢ of the item of software 300 for which multiple versions have been generated. The residual section D (or some or all of its sub parts D₁,D₂, . . . ) may also be encrypted. Each version C_{i,j} (and possibly the residual section D too if that is to be encrypted) is encrypted differently from the other versions. In particular, the cryptographic key and/or the encryption algorithm used to encrypt one version C_{i,j} is different from the cryptographic key and/or the encryption algorithm used to encrypt the other versions C_{s,t} (for (s,t)≠(i,j))—in other words, no two versions C_{i,j} and C_{s,t} are encrypted with both the same cryptographic key and the same encryption algorithm. Let the encrypted form of the version C_{i,j} be represented as E(C_{i,j}). For each encrypted version E(C_{i,j}) (i=1, . . . , N and j=1, . . . , Mᵢ) of a section of the item of software 300, the distributor 120 stores corresponding decryption information K_{i,j} (such as a decryption key and/or an identification of a decryption algorithm) that can be used to decrypt that encrypted version E(C_{i,j}). If the residual section D is also encrypted, then the distributor 120 stores corresponding decryption information K_{D} (such as a decryption key and/or an identification of a decryption algorithm) that can be used to decrypt the encrypted residual section E(D).

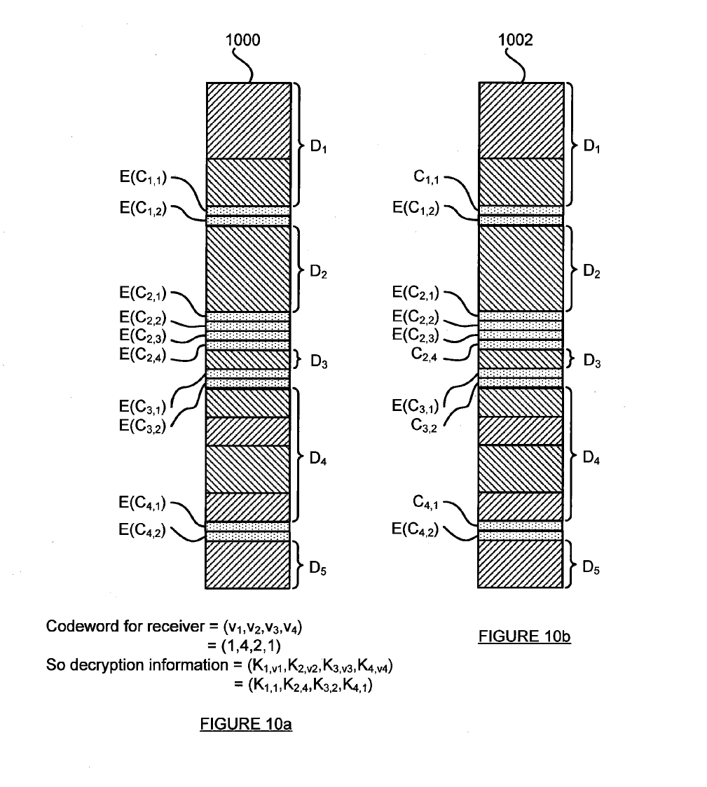

At a step S908, the distributor 120 forms a version of the item of software 300 containing all of the encrypted versions E(C_{i,j}) along with the residual section D (if present) or the encrypted version of the residual section E(D) (if present and encrypted). This shall be described shortly with reference to FIG. 10a.

At a step S910, the receiver 140 sends a request to the distributor 120 requesting a copy or a version of the item of software 300.

At a step S912, the distributor 120 receives the request.

At a step S914, the distributor 120 carries out the step S504 of FIG. 5 to select, for each of the plurality of sections Cᵢ (and possibly D if present) of the item of software 300, a respective version of that section (namely C_{1,v}_{₁}, . . . , C_{N,v}_{_{N}}, and D if present) to be used by the receiver 140, this selection being arranged so that the receiver 140 from which the request was received is identifiable from the set of selected versions.

At a step S916, the distributor 120 communicates (or transmits or provides) the version of the item of software formed at the step S908 to the receiver 140, along with decryption data K that comprises the decryption information K_{1,v}_{₁}, . . . , K_{N,v}_{_{N}} (and K_{D} if the residual section D is present and has been encrypted) corresponding to the encrypted versions (namely C_{1,v}_{₁}, . . . , C_{N,v}_{_{N}}, and D if present) of the sections selected at the step S914.

The decryption data K may be communicated to the receiver 140 in a secure manner so that only the receiver 140 is able to access the decryption information K_{1,v}_{₁}, . . . , K_{N,v}_{_{N}} (and K_{D} if the residual section D is present and has been encrypted). For example, the distributor 120 may encrypt the decryption data K using a public key associated with the receiver 140 and then send this encrypted decryption data K to the receiver 140. In this way, only the intended receiver 140 (which has the private/secret key corresponding to the public key) can decrypt the encrypted decryption data K.

Since the item of software formed at the step S908 may be common to all (or a particular set) of the receivers 140, it can be pre-generated and pre-encrypted. The receivers 140 need the decryption data K to obtain a particular working and fingerprinted version of the item of software. Hence, provision of the decryption data K may make use of a more trusted distribution mechanism than the distribution of the item of software formed at the step S908—thus, the distributor 120 may comprise a first distribution mechanism for providing the item of software formed at the step S908 an a second, more secure, distribution mechanism for providing the decryption data K to receivers 140.

The decryption data K may be combined with the version of the item of software formed at the step S908 (e.g. so as to be part of a data section of the version of the item of software sent to the receiver 140). Alternatively, the decryption data K may be communicated to the receiver 140 separately from the version of the item of software formed at the step S908.

At a step S918, the receiver 140 receives the version of the item of software formed at the step S908, along with the decryption information K_{1,v}_{₁}, . . . , K_{N,v}_{_{N}} (and K_{D} if the residual section D is present and has been encrypted) corresponding to the encrypted versions of the sections selected at the step S914 (namely C_{1,v}_{₁}, . . . , C_{N,v}_{N}, and D if present). The receiver 140 may then use the decryption information K_{1,v}_{₁}, . . . , K_{N,v}_{_{N}} (and K_{D} if the residual section D is present and has been encrypted) to decrypt the corresponding encrypted versions E(C_{1,v}_{₁}), . . . , E(C_{N,v}_{_{N}}) (and E(D) if the residual section D is present and has been encrypted) in order to obtain a version of the item of software 300 specific to that receiver 140. Note that the receiver 140 is not able to decrypt any of the other versions of the sections of the item of software 300, so that the receiver 140 is not able to form a different version of the item of software 300.

To facilitate the above decryption, the key information K may contain data indicating, for each of the encrypted selected versions E(C_{1,v}_{₁}), . . . , E(C_{N,v}_{_{N}}) (and E(D) if the residual section D is present and has been encrypted), the location of the encrypted selected versions within the version of the item of software formed at the step S908, so that the receiver 140 knows which part(s) of the version of the item of software formed at the step S908 that it receives to decrypt. This location information could comprise, for example, an indication of a start and end location for each encrypted selected version and/or an indication of a start location and length value for each encrypted selected version and/or other location data.

The decryption of the encrypted versions of the selected encrypted versions E(C_{1,v}_{₁}), . . . , E(C_{M,v}_{_{M}}) (and E(D) if the residual section D is present and has been encrypted) may be carried out at the receiver 140 in a number of ways. For example, the receiver 140 may execute a specific application which carries out the decryption processing. Alternatively, the software loader run by the receiver 140 may be arranged to perform the decryption processing. Alternatively, the version of the item of software formed at the step S908 may itself contain (in an unencrypted part, such as in the residual section D) functionality to perform the decryption processing, so that the decryption processing is performed at runtime.

Whilst the step S914 is illustrated as being performed in response to the distributor 120 receiving the request from the receiver 140, it will be appreciated that the step S914 may be carried out without having to receive a request from the receiver 140 (e.g. in anticipation of receiving the receiver's request 140). Thus, the step S914 may be carried out prior to the steps S910 and S912. Moreover, in some embodiments of the invention, the steps S910 and S912 may be omitted, for example in embodiments in which the distributor 120 provides automatic software downloads (e.g. software updates) to receivers 140.

Variations of the above method 900 are possible. For example, the step S904 may be omitted—in particular, the distributor 120 may encrypt the versions of the sections of the item of software 300 received at the step S902 and form the version of the item of software (step S908) as one process, so that only the version of the item of software formed at the step S908 is then actually stored by the distributor 120. Alternatively the software source 110 or some other entity (instead of the distributor 120) may perform the encryption of the versions of the sections of the item of software 300 before sending the encrypted versions (instead of the cleartext versions) to the distributor 120 (along with the associated decryption information K_{i,j}). Alternatively the software source 110 or some other entity (instead of the distributor 120) may perform the encryption of the versions of the sections of the item of software 300, and also the formation of the version of the item of software (step S908), before sending that version to the distributor 120 (along with the associated decryption information K_{i,j}). In this case, the distributor 120 may itself perform the decryption the encrypted selected versions E(C_{1,v}_{₁}), . . . , E(C_{M,v}_{_{M}}) (and E(D) if the residual section D is present and has been encrypted) prior to sending the resulting item of software to the receiver 140—in this way, the receiver 140 does not need to carry out any decryption processing itself.

It will be appreciated that instead of forming a single item of software at the step S908, a plurality of such items of software may be formed at the step S908, each of them being for, or associated with, a respective subset of a population of receivers 140. Then, at the step S916, the distributor 120 may communicate to the requesting receiver 140 the item of software for the group of receivers to which the requesting receiver 140 belongs.

FIG. 10a schematically illustrates a version or copy 1000 of the item of software 300 that may be formed at the step S908 of FIG. 9 according to one embodiment of the invention. This example is based on the example item of software 300 illustrated in FIG. 3, and for which the selected sequence of versions is, for example, (v₁,v₂,v₃,v₄)=(1,4,2,1).

As shown in FIG. 10a, the version 1000 of the item of software 300 contains each of the versions C_{i,j} of each selected section Cᵢ of the item of software 300 in encrypted form, i.e. the version 1000 of the item of software 300 contains E(C_{i,j}) for i=1, . . . , N and j=1, . . . , Mᵢ). In FIG. 10a, the residual section D is present in the version 1000 of the item of software 300 in unencrypted form, but it will be appreciated that the residual section D may also be present in the version 1000 of the item of software 300 in encrypted form, i.e. as E(D).

Whilst the version 1000 of the item of software 300 illustrated in FIG. 10a will be larger than the version 700 of the item of software 300 illustrated in FIG. 7, an advantage of this particular version 1000 is that it is the same for all (or at least a subset) of the receivers 140. In other words, the version 1000 is a generic version that can be distributed to all (or at least a subset) of the receivers 140. The only information communicated to a receiver 140 that is specific to that particular receiver 140 is the relatively small amount of decryption data K specific to that receiver 140. This reduces that amount of processing at the distributor 120.

FIG. 10b schematically illustrates the version or copy 1002 of the item of software 300 that may be formed at the step S918 of FIG. 9 according to one embodiment of the invention. In particular the version 1002 illustrated in FIG. 10b corresponds to the version 1000 illustrated in FIG. 10a when the receiver 140 has performed the decryption of the versions C_{1,v}_{₁}, . . . , C_{N,v}_{_{N}} of the sections of the item of software 300 selected for that receiver, as contained in encrypted form within the version 1000, using the decryption data K for that receiver 140. Since the example selected sequence of versions is, for example, (v₁,v₂,v₃,v₄)=(1,4,2,1), the decryption data K communicated to the receiver 140 comprises decryption information K_{1,1}, K_{2,4}, K_{3,2}, K_{4,1} and hence the versions C_{1,1}, C_{2,4}, C_{3,2}, C_{4,1} are decrypted (and hence available for use by the receiver 140), whilst any other encrypted versions remain encrypted in the version 1002.

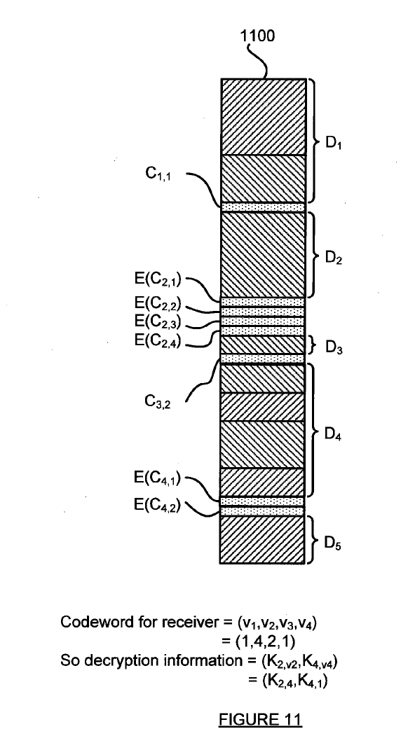

Some embodiments may operate by combining the formats of FIGS. 7 and 10a (and thus the corresponding functionality of the methods 600, 800 and 900). FIG. 11 schematically illustrates an example of such a combined format 1100. In particular, some of the selected versions of sections of the item of software 300, namely the selected versions C_{1,1}, C_{3,2} and D for the first and third sections C₁ and C₃ and the residual section D are contained in the version 1100 of the item of software 300—this follows the format of FIG. 7 (and the associated methods 600 and 800 may apply analogously). In particular, for these sections C₁ and C₃, the other versions C_{1,2} and C_{3,1} are not contained within the version 1100. However, for the other sections C₂ and C₄, the version 1100 of the item of software 300 contains all of the encrypted versions of those sections—this follows the format of FIG. 10 (and the associated method 900 may apply analogously—in particular, the corresponding decryption information K_{2,4} and K_{4,1} for the particular selected versions C_{2,4} and C_{4,1} are provided to the receiver 140).

It will be appreciated that the generation of an item of software specific to the receiver 140 that requested a version of the initial item of software 300 (as set out above) may involve various functions or procedures being moved within the generated item of software (i.e. their memory address changes) relative to where those functions or procedures were initially located within the initial item of software 300. Other process or data flow may be affected similarly. For example, the use of one version C_{i,j} of a section Cᵢ in the version 700 shown in FIG. 7 may result in a function having certain entry/exit addresses, whereas the use of a different version C_{i,k} of that section Cᵢ in the version 700 shown in FIG. 7 may result in a function having different entry/exit addresses. This is particularly true if the versions C_{i,j} for a section Cᵢ are of different sizes. Moreover, the particular form of a generated item of software 1000, 1002, 1100 shown in FIGS. 10a, 10b and 11 may involve the presence of multiple versions of the same function or procedure (albeit in encrypted form)—then, depending on which encrypted section E(C_{i,j}) is decrypted for a particular receiver 140, the process flow may need to enter or exit one decrypted encrypted section E(C_{i,j}) for one receiver 140 but may need to enter or exit a different decrypted encrypted section E(C_{i,k}) for another receiver 140. For example, section C₃ may contain a function H. For a first receiver 140, the version of C₃ selected for the first receiver 140 may be C_{3,2} and so it is C_{3,2} that is decrypted and accessible to the first receiver 140. Therefore, if execution of the item of software requires calling a function H, then process flow needs to continue at an address within C_{3,2}. However, for a second receiver 140, the version of C₃ selected for the second receiver 140 may be C_{3,1} and so it is C_{3,1} that is decrypted and accessible to the second receiver 140. Therefore, if execution of the item of software requires calling the function H, then process flow needs to continue at an address within C_{3,1} instead of an address within C_{3,2}.

Embodiments of the invention may handle the above problems by making use of a so-called “branch table”. Branch tables are well-known and shall not be described in detail herein other than what is necessary for understanding their use with embodiments of the invention. In particular, a branch table acts as a look-up table that associates a function or procedure with its address within an item of software. A branch table can be used as a level of indirection. In particular, instead of an instruction or segment of code within the item of software calling a function or procedure directly, that instruction of segment of code accesses the branch table to look up the address associated with that function, so that process flow and process control can then be redirected to that address. Thus, if the initial item of software 300 does not already make use of a branch table, the initial item of software 300 may be reconfigured so as to make use of a branch table, so that when the item of software is formed specific to a particular receiver 140, it can make use of a suitable branch table with appropriate address information reflecting the addresses of its various functions and procedures. Hence, the item of software generated and provided to the receiver 140 may include a branch table (not shown in FIG. 7, 10a, 10b or 11).

Thus, if the generation of an item of software particular to the receiver 140 that requested a version of the initial item of software 300 (as set out above) involves a function or procedure being moved within the generated item of software (i.e. its address has change) relative to where that function or procedure was initially located within the initial item of software 300, then the branch table can be updated accordingly with the new address information so that correctly addressed function calls and procedure calls can occur.

Similarly, as mentioned above, the particular form of a generated item of software 1000, 1002, 1100 shown in FIGS. 10a, 10b and 11 may involve the presence of multiple versions of a function or procedure (albeit in encrypted form)—then, depending on which encrypted section E(C_{i,j}) is decrypted for a particular receiver 140, the process flow may need to enter or exit one decrypted encrypted section E(C_{i,j}) for one receiver 140 but may need to enter or exit a different decrypted encrypted section E(C_{i,j}) for another receiver 140. The use of a branch table can resolve this problem, as set out below. A first method may simply be for the distributor 120 to modify the branch table before providing it to a receiver 140 so that the branch table reflects the address for a function or procedure that will be relevant when a particular encrypted section E(C_{i,j}) (containing that function or procedure) is decrypted for that receiver 140. Alternatively, if a function or procedure F occurs in a section Cᵢ, then the branch table may contain the address for the function F occurring in each version of the section C_{i,j}. Of course, only one of the versions of the section C_{i,j} will be used (i.e. decrypted) for any given receiver 140, and so the appropriate entry in that branch table corresponding to the address of the function F within that particular versions of the section C_{i,j} will need to be used by that given receiver 140. This can be achieved by arranging for the item of software 1000, 1002, 1100 to make use of the decryption data K to select the appropriate entry for the function F in the branch table. The decryption data K may explicitly identify which entry in the branch table to use for the function F; alternatively, the entry in the branch table may be derived from, for example, the decryption information K_{i,j}. For example, the branch table may contain the following entries:

| Entry no. | Address |
|---|---|
| . . . | . . . |
| 322 | 0x12472551 (= address for function F within C_{2,1}) |
| 323 | 0x12478252 (= address for function F within C_{2,2}) |
| 324 | 0x12484213 (= address for function F within C_{2,3}) |
| 325 | 0x12489669 (= address for function F within C_{2,4}) |
| . . . | . . . |

If the value of v₂ for a particular receiver is 2, then the required address for the function F (that is in the section C₂ and that is, therefore, present in each of C_{2,1}, C_{2,2}, C_{2,3} and C_{2,4}) is the address for the function F in the version C_{2,2}. The decryption data K may include the relevant entry (no. 323 in this case when v₂=2) so that the item of software 1000, 1002, 1100 can look up the correct address for the function F in the version C_{2,2}. Alternatively, the item of software 1000, 1002, 1100 may be arranged to perform one or more tests or operations on the decryption data K (such as the decryption information K_{2,2}) to determine the relevant entry in the branch table. For example, instead of having a fixed branch table from which the appropriate entry is selected, the decryption process carried out by the loader or the software itself can provide the appropriate values in the branch table to enable the software to function properly. This means that the branch table can be completed during the decryption step. Instead of modifying the branch table entries directly, the decryption process could insert code that modifies the branch table during runtime.

In some embodiments, the versions C_{i,j} of a section Cᵢ are all made to be the same size (e.g. by using padding, where necessary). This makes it easier to construct the version of the item of software for the receiver 140 (e.g. it may then be easier to concatenate the versions or insert them into the template when the residual section D is viewed as a template into which the different versions C_{1,v}_{₁}, . . . , C_{N,v}_{_{N}} may be inserted).

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality and process steps may be implemented as hardware and/or software. For example, the above-mentioned functionality and process steps may be implemented as one or more software components for execution by a processor of the system. Alternatively, the above-mentioned functionality and process steps may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method, implemented by one or more processors, of providing a receiver with a version of an initial item of software, the method comprising:
for each of a plurality of sections of the initial item of software that together form the initial item of software, obtaining one or more respective versions of that section, wherein for at least one of the sections a respective plurality of different versions of that section are obtained;
for each of the plurality of sections of the initial item of software, selecting a respective version of that section to be used by the receiver, said selecting being arranged so that the receiver is identifiable from the set of selected versions; and
providing the receiver with a version of the initial item of software by providing the receiver with access to the selected versions of the sections of the initial item of software.

2. The method of claim 1, wherein for each section of the initial item of software for which a respective plurality of different versions of that section are obtained, said respective plurality of different versions are differently watermarked versions of that section.

3. The method of claim 1, wherein providing the receiver with access to the selected versions of the sections of the initial item of software comprises:
forming said version of the initial item of software from the selected versions of the sections of the initial item of software; and
communicating the formed version of the initial item of software to the receiver.

4. The method of claim 1, wherein providing the receiver with access to the selected versions of the sections of the initial item of software comprises:
identifying to the receiver, for each of one or more of said selected versions of the sections of the initial item of software, a corresponding address from which the receiver can obtain that selected version.

5. The method of claim 4, wherein, for at least one version of a section of the initial item of software, obtaining said version of said section of the initial item of software comprises obtaining an address from which the receiver can obtain that version of said section of the initial item of software.

6. The method of claim 1, wherein providing the receiver with access to the selected versions of the sections of the initial item of software comprises:
forming a second item of software, said second item of software comprising:
(a) for one or more of the plurality of sections of the initial item of software, including at least one of the at least one section for which a respective plurality of different versions of that section are obtained, an encrypted version of the or each version of that section, wherein for each of said at least one of the at least one section for which a respective plurality of different versions of that section are obtained the different versions of that section are encrypted differently from each other; and
(b) for each of the sections of the initial item of software other than said one or more of the plurality of sections of the initial item of software, the respective selected version of that section;
communicating the second item of software to the receiver; and
providing the receiver with decryption data to enable the receiver to decrypt each selected version of a section of the initial item of software that is encrypted within the second item of software.

7. The method of claim 6, wherein said obtaining comprises either: (a) obtaining said encrypted versions; or (b) generated said encrypted versions by encrypting corresponding non-encrypted versions.

8. The method of claim 1, wherein:
said obtaining comprises obtaining a second item of software, said second item of software comprising:
(a) for one or more of the plurality of sections of the initial item of software, including said at least one section for which a respective plurality of different versions of that section are obtained, an encrypted version of the or each version of that section, wherein for each of said at least one section for which a respective plurality of different versions of that section are obtained the different versions of that section are encrypted differently from each other; and
(b) for each of the sections of the initial item of software other than said one or more of the plurality of sections of the initial item of software, the respective version of that section; and
wherein providing the receiver with access to the selected versions of the sections of the initial item of software comprises:
communicating the second item of software to the receiver; and
providing the receiver with decryption data to enable the receiver to decrypt each selected version of a section of the initial item of software that is encrypted within the second item of software.

9. The method of claim 1, wherein:
said obtaining comprises obtaining a second item of software, said second item of software comprising:
(a) for one or more of the plurality of sections of the initial item of software, including said at least one section for which a respective plurality of different versions of that section are obtained, an encrypted version of the or each version of that section, wherein for each of said at least one section for which a respective plurality of different versions of that section are obtained the different versions of that section are encrypted differently from each other; and
(b) for each of the sections of the initial item of software other than said one or more of the plurality of sections of the initial item of software, the respective version of that section; and
wherein providing the receiver with access to the selected versions of the sections of the initial item of software comprises:
forming the version of the item of software from the second item of software by decrypting each selected version of a section of the initial item of software that is encrypted within the second item of software; and
communicating the formed version of the item of software to the receiver.

10. The method of claim 5, wherein the second item of software comprises functionality to enable said decryption.

11. The method of claim 5, in which two different versions are encrypted differently if they are encrypted using a different encryption key and/or a different encryption algorithm.

12. The method of claim 1, in which said providing the receiver with access to the selected versions of the sections of the initial item of software is carried out in response to receiving a request from the receiver for a version of the initial item of software.

13. The method of claim 1, in which said for each of the plurality of sections of the initial item of software, selecting a respective version of that section to be used by the receiver is carried out in response to receiving a request from the receiver for a version of the initial item of software.

14. The method of claim 1, wherein, for each section of the initial item of software for which a respective plurality of different versions of that section are obtained, the different versions of that section are arranged such that versions of the initial item of software utilizing, respectively, the different versions of that section would generate the same output data when supplied with the same input data.

15. The method of claim 1, comprising identifying the plurality of sections of the initial item of software that together form the initial item of software.

16. The method of claim 15, wherein said obtaining comprises, for each of said at least one of the sections, generating said plurality of different versions of that section.

17. The method of claim 1, wherein the version of the initial item of software provided to the receiver comprises a branching table to facilitate the control of process flow when the version of the initial item of software is executed by the receiver.

18. The method of claim 9, wherein the version of the initial item of software provided to the receiver comprises a branching table to facilitate the control of process flow when the version of the initial item of software is executed by the receiver, and in which the branching table is generated, at least in part, by the second item of software.

19. A method, implemented by one or more processors, for providing a receiver with a version of an initial item of software, the method comprising:
identifying a plurality of sections of the initial item of software that together form the initial item of software;
for at least one of the plurality of sections, generating a respective plurality of different versions of that section; and
providing the generated versions of the at least one of the plurality of sections, together with any of the plurality of sections other than the at least one of the plurality of sections, to a software distribution system that is arranged to carry out a method according to claim 1.

20. The method of claim 19, wherein said providing comprises providing the software distribution system with an address from which one of more of the generated versions of the at least one of the plurality of sections can be obtained by the receiver and/or from which one or more of any of the plurality of sections other than the at least one of the plurality of sections can be obtained by the receiver.

21. The method of claim 19, wherein said providing comprises:
encrypting, for one or more of said at least one of the plurality of sections, said respective plurality of different versions of that section, wherein said respective plurality of different versions of that section are encrypted differently from each other;
providing said encrypted versions to the software distribution system; and
providing the software distribution system with decryption data to enable decryption of said encrypted versions.

22. The method of claim 19, wherein said providing comprises:
forming a second item of software, said second item of software comprising:
(a) for one or more of the plurality of sections of the initial item of software, including the at least one section for which a respective plurality of different versions of that section are generated, an encrypted version of the or each version of that section, wherein for each of said at least one section for which a respective plurality of different versions of that section are generated the different versions of that section are encrypted differently from each other; and
(b) each of the sections of the initial item of software other than said one or more of the plurality of sections of the initial item of software;
providing said second item of software to said software distribution system; and
providing the software distribution system with decryption data to enable decryption of said encrypted versions.

23. A data structure corresponding to an initial item of software, the data structure comprising:
for each of one or more of a plurality of sections of the initial item of software that together form the initial item of software, at least one encrypted version of that section, there being at least one section for which the data structure comprises a respective plurality of encrypted different versions of that section, the different versions of that section being encrypted differently from each other; and
for each of the plurality of sections of the initial item of software other than said one or more of the plurality of sections of the initial item of software, a respective version of that section.

24. The data structure of claim 23, further comprising decryption data to enable a recipient of the data structure to decrypt one or more encrypted versions of a section of the initial item of software within the data structure.

25. An apparatus comprising one or more processors configured to carry out a method of providing a receiver with a version of an initial item of software, the method comprising:
for each of a plurality of sections of the initial item of software that together form the initial item of software, obtaining one or more respective versions of that section, wherein for at least one of the sections a respective plurality of different versions of that section are obtained;
for each of the plurality of sections of the initial item of software, selecting a respective version of that section to be used by the receiver, said selecting being arranged so that the receiver is identifiable from the set of selected versions; and
providing the receiver with a version of the initial item of software by providing the receiver with access to the selected versions of the sections of the initial item of software.

26. (canceled)

27. A tangible non-transitory computer readable medium storing a computer program which, when executed by one or more processors, causes the one or more processors to carry out a method of providing a receiver with a version of an initial item of software, the method comprising:
for each of a plurality of sections of the initial item of software that together form the initial item of software, obtaining one or more respective versions of that section, wherein for at least one of the sections a respective plurality of different versions of that section are obtained;
for each of the plurality of sections of the initial item of software, selecting a respective version of that section to be used by the receiver, said selecting being arranged so that the receiver is identifiable from the set of selected versions; and
providing the receiver with a version of the initial item of software by providing the receiver with access to the selected versions of the sections of the initial item of software.

28. The method of claim 6, wherein the second item of software comprises functionality to enable said decryption.

29. The method of claim 8, wherein the second item of software comprises functionality to enable said decryption.

30. The method of claim 9, wherein the second item of software comprises functionality to enable said decryption.

31. The method of claim 6, in which two different versions are encrypted differently if they are encrypted using a different encryption key and/or a different encryption algorithm.

32. The method of claim 8, in which two different versions are encrypted differently if they are encrypted using a different encryption key and/or a different encryption algorithm.

33. The method of claim 9, in which two different versions are encrypted differently if they are encrypted using a different encryption key and/or a different encryption algorithm.

34. An apparatus comprising one or more processors configured to carry out a method for providing a receiver with a version of an initial item of software, the method comprising:
identifying a plurality of sections of the initial item of software that together form the initial item of software;
for at least one of the plurality of sections, generating a respective plurality of different versions of that section; and
providing the generated versions of the at least one of the plurality of sections, together with any of the plurality of sections other than the at least one of the plurality of sections, to a software distribution system, wherein said software distribution system comprises one or more processors configured to provide a receiver with a version of an initial item of software by: for each of a plurality of sections of the initial item of software that together form the initial item of software, obtaining one or more respective versions of that section, wherein for at least one of the sections a respective plurality of different versions of that section are obtained; for each of the plurality of sections of the initial item of software, selecting a respective version of that section to be used by the receiver, said selecting being arranged so that the receiver is identifiable from the set of selected versions; and providing the receiver with a version of the initial item of software by providing the receiver with access to the selected versions of the sections of the initial item of software.

35. A tangible non-transitory computer readable medium storing a computer program which, when executed by one or more processors, causes the one or more processors to carry out a method for providing a receiver with a version of an initial item of software, the method comprising:
identifying a plurality of sections of the initial item of software that together form the initial item of software;
for at least one of the plurality of sections, generating a respective plurality of different versions of that section; and
providing the generated versions of the at least one of the plurality of sections, together with any of the plurality of sections other than the at least one of the plurality of sections, to a software distribution system, wherein said software distribution system comprises one or more processors configured to provide a receiver with a version of an initial item of software by: for each of a plurality of sections of the initial item of software that together form the initial item of software, obtaining one or more respective versions of that section, wherein for at least one of the sections a respective plurality of different versions of that section are obtained; for each of the plurality of sections of the initial item of software, selecting a respective version of that section to be used by the receiver, said selecting being arranged so that the receiver is identifiable from the set of selected versions; and providing the receiver with a version of the initial item of software by providing the receiver with access to the selected versions of the sections of the initial item of software.
